(19) United States
(12) Patent Application Publication
(10) Pub. No.: US 2025/0102034 A1
(43) Pub. Date: Mar. 27, 2025

(54) TORSION SPRING WITH ADJUSTABLE LENGTH

(71) Applicant: Zhide DAVID FENG, Township Of Northville, MI (US)

(72) Inventor: Zhide DAVID FENG, Township Of Northville, MI (US)

(21) Appl. No.: 18/805,451

(22) Filed: Aug. 14, 2024

Related U.S. Application Data
(60) Provisional application No. 63/532,628, filed on Aug. 14, 2023.

(51) Int. Cl. F16F 1/16; F16F 1/14

(52) U.S. Cl. CPC F16F 1/16; F16F 1/145

(57) ABSTRACT

A torsion spring with adjustable length comprises a coil spring body having a first end and a second end; a first spring end connector being connected with said first end of said spring; and a second spring end connector being connected with said second end of said spring; at least one of the said first spring end connector and said second spring end connector also having a plurality of removable spacers.

### BACKGROUND OF THE INVENTION

A torsion spring for a garage door is a type of mechanical spring used to assist in the operation of a overhead door, or garage door moving up and down by providing the necessary force to counterbalance its weight. Garage doors, especially larger and heavier ones, can be difficult to open and close due to their weight, no matter manually or by an electric opener. Torsion springs are designed to store and release energy as the door is operated, making it easier to lift and lower the door.

In the section of preferred embodiment of PCT/US2021/058477, the installation and operation of a typical torsion spring for a garage door has been illustrated.

Torsion springs are designed to have a specific amount of tension based on the weight and size of the garage door. It's crucial to ensure that the correct size and type of torsion springs are installed, as improperly installed or damaged springs can pose a safety risk.

Usually this kind of springs are classified by their internal diameter (ID), wire diameter, and nominal length.

Currently, even for the same ID and wire diameter, the exact nominal length is still important for a specific garage door. In the garage door industry, usually the increment of the length of a spring is one inch, or even half an inch. This situation makes the portfolio for inventory of a garage door company more complicated.

For a DIY handyperson to install or replace a spring, an appropriate spring with correct length is to be ordered first. If it is found that the ordered spring does not have correct length, then it needs to be returned and exchanged for one with correct length, leading to waste of time and logistic cost.

Therefore, if there is in some way that the length of a spring is adjustable, it will help to improve this situation.

### SUMMARY OF THE INVENTION

A torsion spring with adjustable length comprises a coil spring body having a first end and a second end; a first spring end connector being connected with said first end of said spring; and a second spring end connector being connected with said second end of said spring; at least one of the said first spring end connector and said second spring end connector also having a plurality of removable spacers.

### EXPLANATION OF THE DRAWINGS

FIG. 1 shows a general view of a typical torsion spring of prior arts for a garage door;

FIG. 2 shows an exploded view of the spring of this prior arts;

FIG. 3 shows a general 3D view of the preferred embodiment for the present invention, a torsion spring with adjustable length;

FIG. 4 shows the coil spring body for the present invention;

FIG. 5 through FIG. 7 show the adjustable winding cone assembly;

FIG. 8 shows the shortened status of the second embodiment of the present invention;

FIG. 9 shows the shortened status of the preferred embodiment of the present invention;

FIG. 10 shows the extended status of the preferred embodiment of the present invention;

FIG. 11 shows the extended status of the second embodiment of the present invention;

FIG. 12 shows the adjustable stationary cone assembly for the second embodiment of the present invention in extended status;

FIG. 13 shows an exploded view for the adjustable stationary cone assembly for the second embodiment of the present invention in shortened status;

FIG. 14 shows the third embodiment which is a variant from preferred embodiment with elimination of the stationary cone.

### DETAILED DESCRIPTION OF THE PREFERRED EMBODIMENT OF THE INVENTION

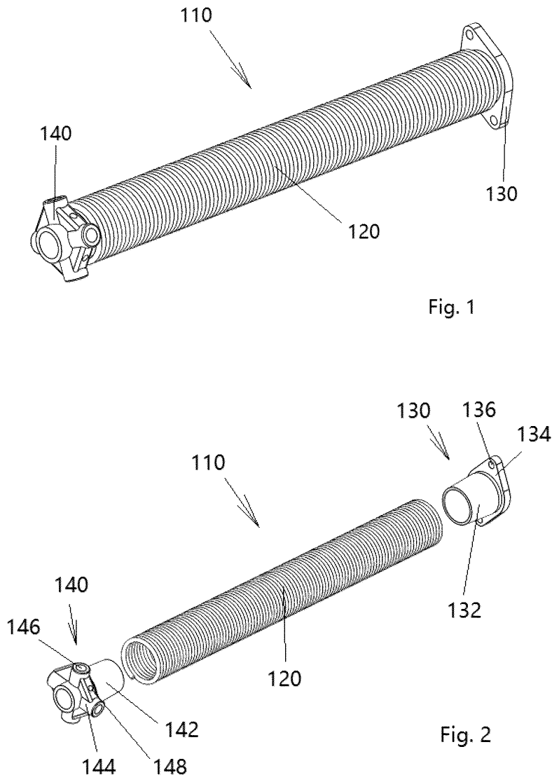

A typical torsion spring for a garage door of prior arts 110 is shown at FIG. 1. Said 110 has coil spring body 120, a stationary cone, or first spring end connector 130 fixed with the first end, or stationary end of said 120, and a winding cone, or second spring end connector 140 fixed with the second end, or winding end of 120.

FIG. 2 shows an exploded view of this torsion spring.

Said 120 is a typical coil spring body with spiral shape with sharp cut at each end.

Said 130 usually has a cone portion 132, and a flange portion 134 usually with a diamond shape. Said 134 usually has two holes 136 with each one at each longitude end of said 134.

Said 140 usually has a cone portion 142, and a star shaped winding portion 144. Said 144 usually has four tube-shaped protrusion 146, and two threaded through holes 148. Two set screws are to be used to engage with said 148 for fixing 140 to the central shaft shown at PCT/US2021/058477.

The cone portion 132 (142) is used to be fixed with the first end (second end) of said 120 by coiling in with crescendo, or increased gradually status.

For installing said 110 to the garage door system, said stationary cone is fixed with the wall structure shown at PCT/US2021/058477, while the winding cone is fixed with the central shaft.

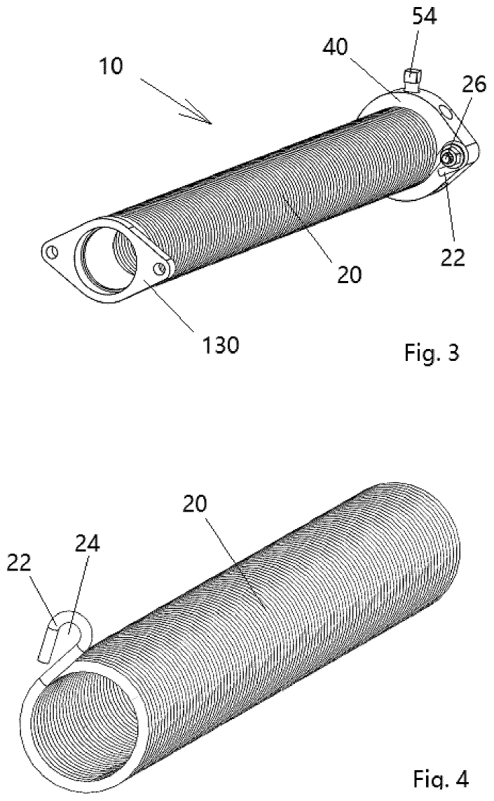

FIG. 3 shows a general 3D view for the present invention of a torsion spring with adjustable length 10. Said 10 has a coil spring body 20, a traditional stationary cone 130, and an adjustable winding cone assembly 40.

As shown at FIG. 4, the only difference between said 20 and said 120 is that one end of said 20 has an extended loop portion 22 within which has a hole 24. This end at this case is the second end of said 20.

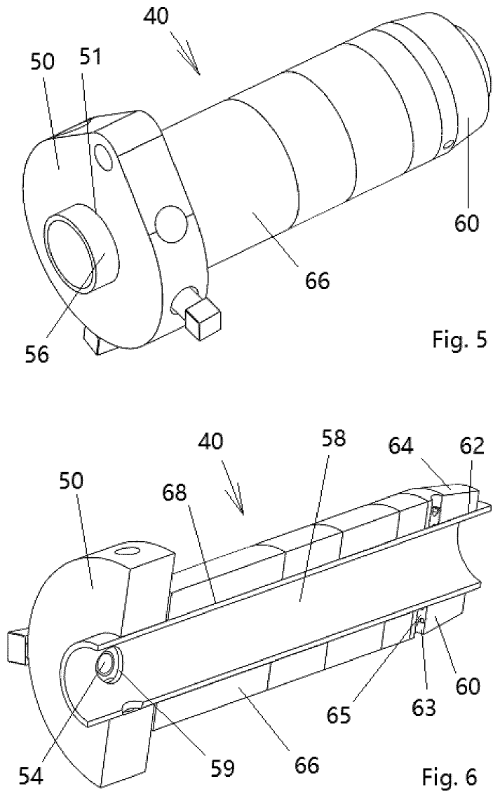

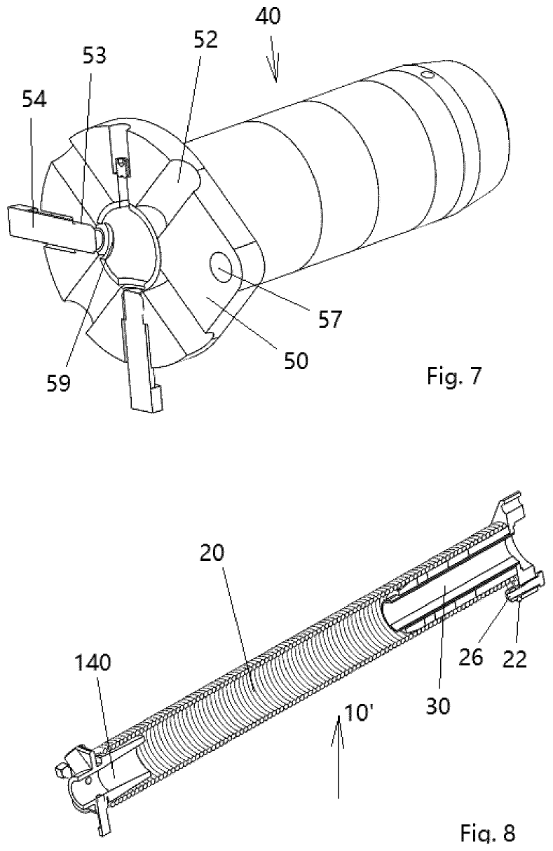

Referring to FIG. 5 through FIG. 7, said winding cone assembly 40 has a winding flange portion 50, a central pipe 56, a cone head 60, and optional a plurality of collar-shaped spacers 66.

Said 50 has a through hole 51 at its center, a plurality of winding holes 52 in the normal direction of 50, each for being able to be engaged by a winding bar, a plurality of threaded holes 53 in the normal direction of 50 for being engaged with set screws 54 to fix said 50 with the central shaft. Said 50 also has a through hole 57 to be engaged with said 24 of said 20.

Said central pipe 56 has a through hole 58 along its longitude direction for pivotally engagement with the central shaft, and a plurality of holes 59 at normal direction for being passed through by said set screws 54.

Said 50 and said 56 can also be combined and made as one-unit piece, by means such as die casting.

Said 60 has a through hole 62 at its axial direction, a cone-shaped portion 64, and a plurality of threaded holes 63 at the normal direction of 60. Said 62 is to be pivotally engaged with the external circular surface of said 56, but with a set screw 65 engaged fully with said 63, said 60 is fully fixed with 56.

Said 66 has a through hole 68 along its axial direction. Said 68 is to be pivotally engaged with external circular surface of said 56 too.

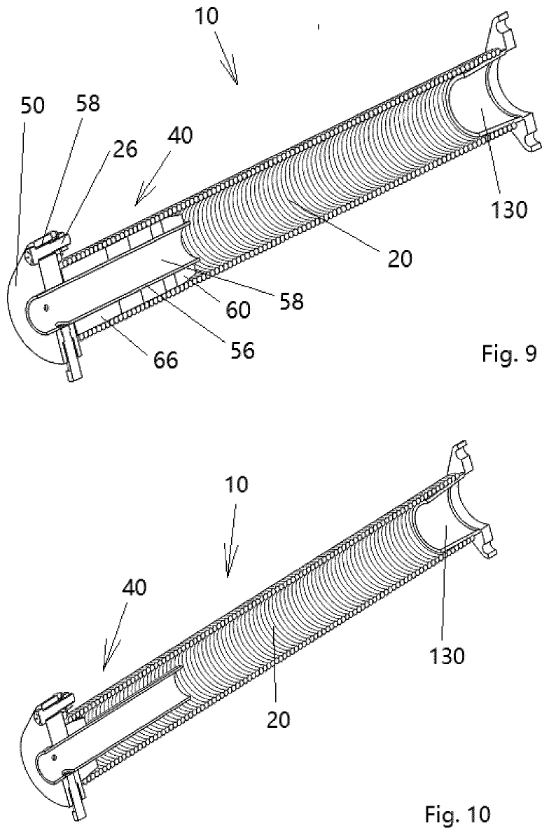

FIG. 9 shows the engagement of said 20 with said 130 on its first end, and with said 40 on its second end.

The internal diameter (ID) of said 20 is pretty much the same as the external diameter of said 60 and 66.

The portion including said 60 and said 66 of pre-assembled said 40 is received to the second end of said 20. A fastener 26 passes through said 57 and said 24 for fixing the second end of said 20 and said 40 together.

FIG. 9 shows the shortened status of said 10, in which there is an overlapped area between said 66 and said 20. In this case not the full length of the spring is functioning, but the overlapped area of said 20 is invalided.

For instance, if a spring with ID of 2 inches, wire diameter of 0.25 inch, and nominal length of 28 inches, and the overall length of 66 is 4.5 inches, then this torsion spring 10 is equivalent to a conventional torsion spring 110 with ID of 2 inches, wire diameter of 0.25 inch, and nominal length of 23.5 inches.

FIG. 10 shows the extended status of said 10, in which said 66 are removed. Then this spring 110 is equivalent to a typical torsion spring with ID of 2 inches, wire diameter of 0.25 inch, and nominal length of 28 inches.

FIG. 5 and FIG. 9 show that said 66 is stackable.

### OTHER EMBODIMENTS

Above preferred embodiment 10 chooses its winding cone as the adjustable end, or invalidation end.

Referring to FIG. 8, different from said 10, the second embodiment 10′ chooses the stationary cone of the spring as the adjustable end.

FIG. 8 shows a general 3D view for the second embodiment of a torsion spring with adjustable length 10′ in shortened status. Said 10′ has a coil spring body 20, a traditional winding cone 140, and an adjustable stationary cone assembly 30.

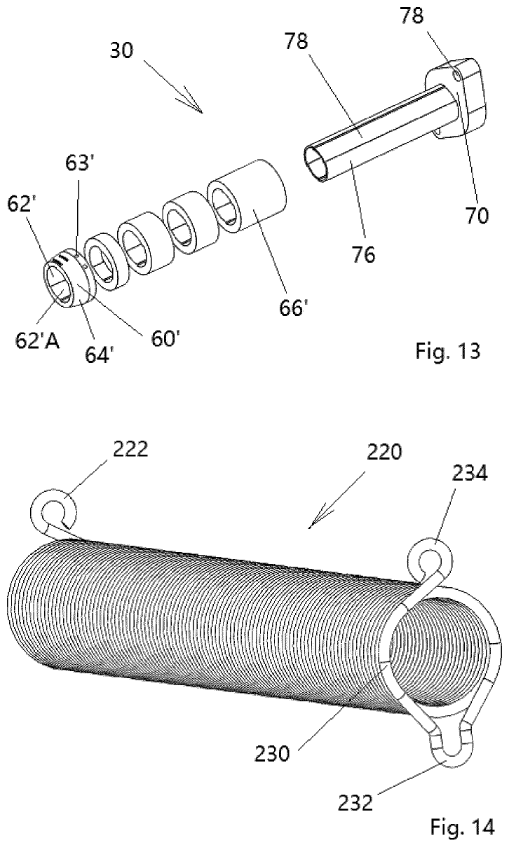

FIG. 12 and FIG. 13 show said stationary cone assembly 30 has a stationary flange portion 70, a central pipe 76, a cone head 60′, and optional a plurality of removable collar-shaped spacers 66′.

Optionally said 76 can have non-circular shape. Accordingly, said 60′ and said 66′ both have similar non-circular shape matching that of said 76. Said 76 has key way 78.

The cone head 60′ has a through hole 62′ at its axial direction, a cone-shaped portion 64′, and a plurality of threaded holes 63′ at the normal direction of 60. Said 62′ is to be pivotally engaged with the external circular surface of said 76, and internal protrusion 62′A on said 62′ is for engagement with said 78.

With a set screw 65 (not shown) engaged fully with said 63′, said 60′ is fully fixed with 76.

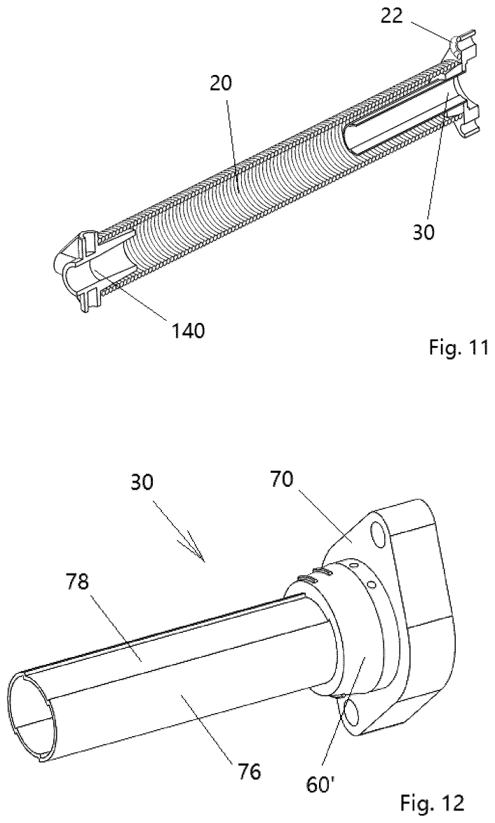

FIG. 11 shows the extended status of the second embodiment of the present invention.

FIG. 14 shows the third embodiment 10″ which is a variant from preferred embodiment with elimination of the stationary cone from said 10. Said 10″ has a coil spring body 220, which has a first end 230 and a second end having an extended loop portion 222.

Said 230 has at least one loop portion but usually has a first loop portion 232 and a second portion 234.

These at least one loop portions are fixed with the wall structure through fasteners.

Said 10″ also has an adjustable winding cone assembly 40 (not shown at FIG. 14) fixed with the second end of said 220, by a fastener 58 engaging said 222 and said 57.

The cone head 60′ (60) is not a must-have element. Another embodiment just eliminates said 60′ (60) of said 10′ (10). If at least one said 66′ (66) is used to be engaged with said 76 (56), it can be just fixed by friction.

In summary, the present invention of a torsion spring with adjustable length comprises a coil spring body having a first end and a second end; a first spring end connector being connected with said first end of said spring; and a second spring end connector being connected with said second end of said spring; at least one of the said first spring end connector and said second spring end connector also having a plurality of removable spacers.

It is claimed that:

1. A torsion spring with adjustable length comprises a coil spring body having a first end and a second end; a first spring end connector being connected with said first end of said spring body; and a second spring end connector being connected with said second end of said spring body; at least one of the said first spring end connector and said second spring end connector also having a plurality of removable spacers.

2. A torsion spring with adjustable length of claim 1, in which said at lease one of the said first spring end connector and said second spring end connector also having a cone head.

3. An adjustable spring end connector for being fixed with one end of a torsion spring, said connector comprising: a flange portion; and a plurality of removable spacers.

4. A torsion spring with adjustable length comprises a coil spring body having a first end and a second end; a second spring end connector being connected with said second end of said spring body; said first end of said spring body having at least one loop portion; said second spring end connector having a plurality of removable spacers.

5. A torsion spring with adjustable length of claim 4, in which said connector having a winding flange portion and a central pipe.
